(19) United States
(12) Patent Application Publication
(10) Pub. No.: US 2011/0092124 A1
(43) Pub. Date: Apr. 21, 2011

(54) DOOR LINING, ESPECIALLY FOR A MOTOR VEHICLE, AND PRODUCTION METHOD

(75) Inventors: Bernd Brendel, Kempen (DE); Thorsten Meyer, Krefeld (DE)

(73) Assignee: Johnson Control Technology Company, Holland, MI (US)

(21) Appl. No.: 12/446,377

(22) PCT Filed: Oct. 18, 2007
(86) PCT No.: PCT/EP2007/009041

§ 371 Date: Dec. 9, 2010

(30) Foreign Application Priority Data
Oct. 20, 2006 (DE) 10 2006 050 474.7
Mar. 29, 2007 (DE) 10 2007 015 600.8

(51) Int. Cl. B32B 27/12; D04H 13/00; B32B 5/26; B29C 65/02

(52) U.S. Cl. 442/381; 442/414; 442/398; 264/241

(57) ABSTRACT

A separator is provided, such as for dividing an outer wet area from an inner dry area between sheet metal of a vehicle door and the door lining. The separator includes a composite of a separating film and an absorbent nonwoven material. The latter material comprises a base web of plastic fibers.

### CROSS REFERENCE TO RELATED APPLICATIONS

This application claims priority from and the benefit of PCT Application No. PCT/EP2007/009041, filed on Oct. 18, 2007; and German Patent No. DE 10 2006 050 474.7, filed on Oct. 20, 2006; and German Patent DE 10 2007 015 600.8, filed on Mar. 29, 2007; all entitled “Door Lining, Especially for a Motor Vehicle, and Production Method”, which are herein incorporated by reference.

### BACKGROUND

The present invention relates to a separating means, which divides the space between the sheet metal of a door and a door lining into an outer wet area and an inner dry area, and consists of a composite of a separating film and an absorbent nonwoven material. The present invention also relates to a method for producing a separating means and to a vehicle door.

The generic separating means is known, for example, from DE 103 26 154 A1, U.S. Pat. No. 6,197,403 B1, DE 35 10 018 C2 and G 82 25 069. The vehicle door described in the documents is provided with a door lining on the interior side, the space that is enclosed by the outer sheet metal of the door and the door lining being divided by means of a separating means into an outer wet area and an inner dry area.

The object of the present invention was to improve the acoustic properties of the separating film.

The object is achieved by a separating means which divides the space between the sheet metal of the door and the door lining into an outer wet area and an inner dry area, said means consisting of a composite of a separating film and an absorbent nonwoven material and the absorbent nonwoven material consisting of a base web of plastic fibers.

### SUMMARY

It was entirely surprising and unexpected for a person skilled in the art that improved acoustic absorption properties can be achieved with the separating means according to the invention. As a result, the noise in the interior of the vehicle is significantly reduced, which enhances the traveling comfort of the vehicle occupants.

According to the invention, the separating means comprises an absorbent nonwoven material with a base web of plastic fibers. The plastic fibers are preferably polyester fibers and/or polypropylene fibers. With particular preference, the weight ratio between polyester fibers and polypropylene fibers is from 25:75 to 35:55, with particular preference however 30:70.

The base web preferably has a weight per unit area of from 150 to 500 grams/m², with most particular preference 170 to 220 grams/m².

The base web preferably has a thickness of from 5 to 30 mm, preferably 7 to 20 mm.

The separating film that is likewise present according to the invention is preferably produced from polyolefin, with particular preference from polypropylene. The film preferably has a thickness of between 0.1 and 4 mm, preferably 1 to 2 mm.

The separating means according to the invention preferably additionally comprises a top web. The top web preferably consists substantially, with most particularly preference consists completely, of polypropylene (PP), in order to improve the adhesion to the PP backing. One function of the top web may be to provide protection for the comparatively fibrous base web.

The absorbent nonwoven material is preferably arranged between the top web and the separating film.

However, it is also conceivable to produce the base web from some other plastics material, for example polyether sulfone (PES), and then provide it with an adhesion promoter, for example polyethylene powder, in order to make possible or improve the bond between the PP backing and the base web.

The present invention also relates to a method for producing a separating means which comprises a separating film and an absorbent nonwoven material, in which method the separating film and the absorbent nonwoven material are jointly deformed, preferably thermoformed.

The separating means is preferably the separating means according to the invention described above.

During the thermoforming, the absorbent nonwoven material and the separating film are preferably not only deformed but also integrally bonded to each other. This integral bonding takes place in particular by the absorbent nonwoven material and/or the separating film being heated to such a degree that, after or when they are placed one on top of the other, possibly with the application of pressure, they integrally bond to each other when they subsequently cool down. This preferred embodiment of the method according to the invention has the advantage that no adhesive has to be used between the separating film and the absorbent nonwoven material.

The separating film is preferably heated before the deforming. The separating film is in this case preferably heated at least up to its plastication temperature.

The present invention also relates to a vehicle door comprising the separating means according to the invention or a separating means produced by the method according to the invention.

The vehicle is preferably a motor vehicle, in particular a passenger car or a truck.

### DRAWINGS

The invention is explained below with reference to FIGS. 1 to 5. These explanations are given merely by way of example and do not restrict the general concept of the invention. The explanations apply equally to all aspects of the subject matter of the present invention.

FIG. 1 shows the heating of the separating film.

FIG. 2 shows the arranging of the absorbent nonwoven material above the separating film.

FIG. 3 shows the joint thermoforming of the separating film and the absorbent nonwoven material.

FIG. 4 shows the punching of the composite of separating film and absorbent nonwoven material.

FIG. 5 schematically shows the separating means according to the invention.

### DETAILED DESCRIPTION

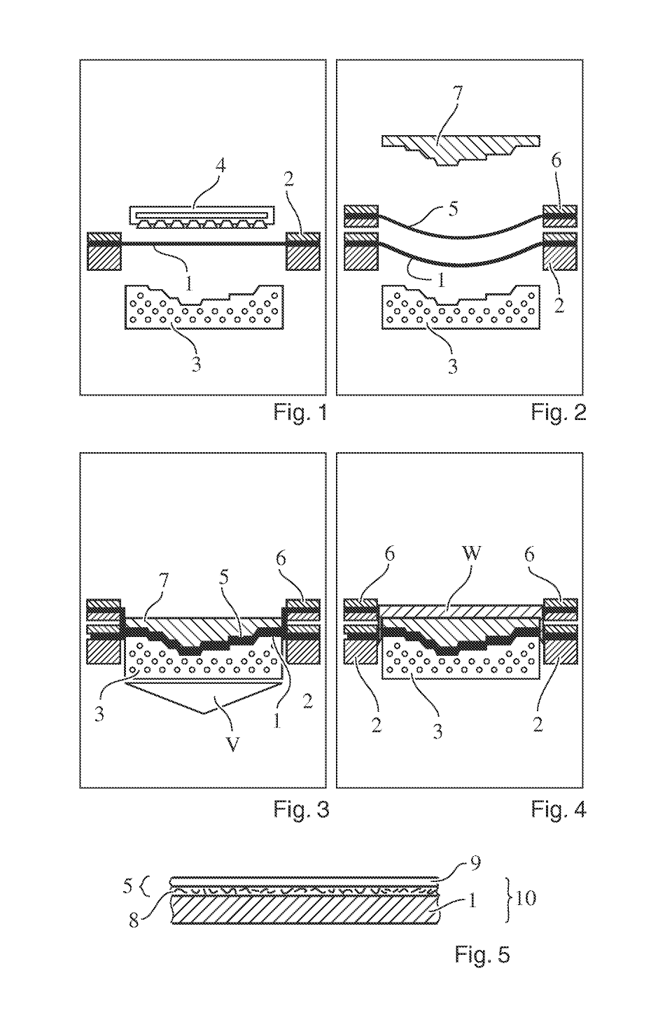

Firstly, as shown in FIG. 1, the still planar separating film 1 is clamped into a first frame 2, positioned above a thermoforming mold 3 and heated from above by means of a heater 4, until it has reached at least its plastification temperature. The heating 4 of the separating film 1 may take place by introducing energy in any way familiar to a person skilled in the art, for example by means of radiation, contact heating, convection, ultrasound or a combination of these. After the method step of heating 4, an absorbent nonwoven material 5, which is specified in more detail below and is held by a further frame 6, is arranged above the separating film (FIG. 2). By means of a punch 7, which can be moved in the direction of the thermoforming mold 3 and may, for example, consist of a foam 10 cm thick, the absorbent nonwoven material 5 and the separating film 1 are jointly pressed into the thermoforming mold 3 and simultaneously drawn onto the three-dimensionally formed mold surface thereof by a vacuum V (FIG. 3). The still present residual heat of the separating film 1 has the effect that the separating film 1 and the absorbent nonwoven material 5 thereby enter into an intimate bond, in particular an integral bond, which can subsequently be brought into the desired form and provided with the necessary recesses by punching (die W in FIG. 4). After that, the punch 7 and the thermoforming mold 3 are moved away from each other again and the separating means produced can be removed. Alternatively, the separating film 1 is heated up and then pre-blown. In a next step, a thermoforming punch moves into the pre-blown separating film 1 and a vacuum is applied, so that the separating film comes to lie against the thermoforming punch. Subsequently, the absorbent nonwoven material 5 is pressed with a foam punch onto the thermoformed separating film. The method according to the invention can be carried out very easily and at low cost. The deforming of the separating film and of the absorbent nonwoven material and the integral bonding thereof take place in one method step, so that the method according to the invention can be carried out much more easily than the methods according to the prior art.

Preferably used as the absorbent nonwoven material 5 is a composite with a base web 8, which consists of polyester fibers and polypropylene fibers, preferably in a weight ratio of from 25:75 to 35:55, in particular approximately 30:70. A top web 9, which contains exclusively polypropylene fibers and lends the composite a certain strength, or protects the very fibrous absorbent nonwoven material, is placed onto this sheetlike formation, preferably at least on one side. In the case of an only two-layer absorbent nonwoven material 5, after pressing onto the separating film 1, this top web 9 is preferably arranged on the side of the sheet facing away from said film, as represented in FIG. 5. The layers 8, 9 are preferably integrally bonded to each other, by sealing or adhesion. The production of the absorbent nonwoven material takes place at a time preferably before the method according to the invention is carried out.

Preferably, a single-layer absorbent nonwoven material, the at least one surface, preferably both surfaces, of which calendered, i.e. heat-treated for example, in order to strengthen them.

For better adhesion, PP and/or PE fibers may be admixed to a nonwoven material of PES fibers.

1. A separator which divides the space between sheet metal of a door and a door lining into an outer wet area and an inner dry area, comprising a composite of a separating film and an absorbent nonwoven material, wherein the absorbent nonwoven material comprises a base web of plastic fibers.

2. The separator as claimed in claim 1, wherein the plastic fibers are polyester fibers, polypropylene fibers, polyamide fibers, polyethylene fibers and/or PES fibers.

3. The separator as claimed in claim 2, wherein a weight ratio between polyester fibers and polypropylene fibers is from 25:75 to 35:55, in particular approximately 30:70.

4. The separator as claimed in claim 1, wherein the base web is bonded to a top web of plastic fibers.

5. The separating means as claimed in claim 1, wherein the separating film comprises polyolefin.

6. The separator as claimed in claim 3, wherein the absorbent nonwoven material is arranged between the top web and the separating film.

7. A method for producing a separator as claimed in claim 1, wherein the separating film and the absorbent nonwoven material are jointly deformed.

8. The method as claimed in claim 7, wherein the absorbent nonwoven material and the separating film are integrally bonded.

9. The method as claimed in claim 7, wherein the separating film is heated before the deforming.

10. A vehicle door comprising a separator as claimed in claim 1.

11. The vehicle door of claim 10, wherein the separator is produced in accordance with claim 7.

12. The separator of claim 4, wherein the plastic fibers of the top web comprise polypropylene fibers.

13. The separator of claim 5, wherein the separating film comprises polypropylene.

14. The method of claim 7, wherein the separating film and the absorbent nonwoven material are thermoformed.

15. The method of claim 8, wherein the absorbent nonwoven material and the separating film are integrally bonded during thermoforming.
